(19) United States
(12) Patent Application Publication
(10) Pub. No.: US 2026/0034794 A1
(43) Pub. Date: Feb. 5, 2026

(54) LIQUID EJECTING APPARATUS

(71) Applicant: Seiko Epson Corporation, Tokyo (JP)

(72) Inventors: Shoma KUDO, Shiojiri-shi (JP); Yohei Onuma, Shiojiri-shi (JP)

(73) Assignee: Seiko Epson Corporation, Tokyo (JP)

(21) Appl. No.: 18/620,386

(22) Filed: Mar. 28, 2024

(30) Foreign Application Priority Data
Mar. 29, 2023 (JP) 2023-054129

(51) Int. Cl. B41J 2/175

(52) U.S. Cl. CPC B41J 2/17553; B41J 2/1754; B41J 2/17596; B41J 2/17506

(57) ABSTRACT

The liquid ejecting apparatus includes an ejecting head configured to eject a liquid and a liquid container configured to contain a liquid to be supplied to the ejecting head. The liquid container includes a liquid containing portion configured to contain a liquid and a liquid filling portion through which a liquid is filled into the liquid containing portion. Further, the liquid container includes a liquid supplying portion to which one end portion of a supply flow path for supplying the liquid to the ejecting head is coupled and through which the liquid in the liquid containing portion is supplied, and a liquid discharging portion through which the liquid contained in the liquid containing portion is discharged outside. The liquid discharging portion is disposed at a bottom surface or a lower portion of a side surface of the liquid containing portion.

The present application is based on, and claims priority from JP Application Serial Number 2023-054129, filed Mar. 29, 2023, the disclosure of which is hereby incorporated by reference herein in its entirety.

### BACKGROUND

### 1. Technical Field

The present disclosure relates to a liquid ejecting apparatus.

### 2. Related Art

For example, JP-A-2018-069717 discloses, as an example of a liquid ejecting apparatus, an ink jet type printing apparatus including an ejecting head that ejects a liquid such as ink onto a medium such as paper.

The liquid ejecting apparatus includes an ink tank as an example of a liquid container that contains a liquid to be supplied to the ejecting head.

In addition, an ink cartridge type liquid ejecting apparatus in which an ink cartridge can be detachably mounted is also known. In a case of the ink cartridge type, when an ink runs out, the entire ink cartridge is replaced. However, since the liquid container such as the ink tank is basically assembled to a housing, when an ink runs out, a user couples an ink bottle to an ink filling flow path portion of the liquid container to replenish the liquid container with a liquid from the ink bottle.

When the liquid ejecting apparatus is discarded, in a case of the ink cartridge type, since a valve is built in a supplying portion of the ink cartridge, even when, for example, the ink cartridge comes off from the apparatus, a large amount of liquid such as ink hardly leaks. On the other hand, in a case of the liquid container such as the ink tank, when the discarded liquid ejecting apparatus is inclined in a state in which a cap of the liquid container comes off, the liquid in the liquid container may spill.

Therefore, when the liquid ejecting apparatus of the ink tank type is discarded, it is preferable that a user collect the liquid in the liquid container and then discard the liquid ejecting apparatus.

However, in the liquid ejecting apparatus including the liquid container of a liquid replenishment type, the liquid container has a structure in which it is hard to detach the liquid container from the housing. Specifically, as a part of the liquid ejecting apparatus, the liquid container is screwed to the housing of the liquid ejecting apparatus via a sheet metal, so that the liquid container is strongly fixed so as not to be affected by an external impact during transportation, for example. For this reason, the liquid ejecting apparatus is discarded with the liquid container being assembled. As described above, in the liquid container of the liquid replenishment type in the related art, no consideration is given to a configuration in which the liquid remaining in the liquid container is discharged or collected when the liquid ejecting apparatus is discarded.

For example, in order to discharge or collect the liquid in the liquid container, it is necessary to detach a coupling portion of the liquid container and a supply flow path such as a tube to extract the liquid from a supplying portion or extract the liquid from a replenishment port for replenishment of a liquid. Since the coupling portion and the replenishment port are not structured in consideration of the extraction of the liquid, the liquid may spill during the extraction operation, or the liquid such as ink may adhere to fingers and soil the fingers. Specifically, a liquid supplying portion through which a liquid such as ink is supplied from the liquid container to the ejecting head has a structure in which a tube is press-fitted and cannot easily be inserted or removed. Therefore, when the tube is detached from the liquid supplying portion, the ink in the liquid container may spill outside from a supplying port of the liquid supplying portion. Therefore, there is a demand for a liquid container and a liquid ejecting apparatus in which the liquid remaining in the liquid container is easily discharged or collected when the liquid ejecting apparatus is discarded.

### SUMMARY

To solve the problem above, a liquid ejecting apparatus includes an ejecting head configured to eject a liquid and a liquid container configured to contain a liquid to be supplied to the ejecting head. The liquid container includes a liquid containing portion configured to contain a liquid, a liquid filling portion through which a liquid is filled into the liquid containing portion, a liquid supplying portion to which one end portion of a supply flow path for supplying the liquid to the ejecting head is coupled and through which the liquid in the liquid containing portion is supplied, and a liquid discharging portion through which the liquid contained in the liquid containing portion is discharged outside. The liquid discharging portion is disposed at a bottom surface or a lower portion of a side surface of the liquid containing portion.

### BRIEF DESCRIPTION OF THE DRAWINGS

FIG. 1 is a perspective view of a liquid ejecting apparatus according to a first embodiment.

FIG. 2 is a perspective view of the liquid ejecting apparatus when a liquid container is replenished with a liquid.

FIG. 3 is a schematic sectional side view of the liquid ejecting apparatus illustrating an internal structure.

FIG. 4 is a schematic sectional side view of the liquid container.

FIG. 5 is a schematic sectional side view of the liquid container and an ejecting head.

FIG. 6 is a schematic sectional side view illustrating a process of moving the liquid container to break coupling of the liquid container and a supply flow path.

FIG. 7 is a schematic sectional side view of the liquid container and a collection container.

FIG. 8 is a schematic sectional side view illustrating a state in which the liquid is collected from the liquid container to the collection container.

FIG. 9 is a schematic sectional side view of a liquid container and a discharge coupling structure portion in a first example of a second embodiment.

FIG. 10 is a schematic sectional side view of a liquid container and a discharge coupling structure portion in a second example.

FIG. 11 is a schematic sectional side view of a liquid container and a discharge coupling structure portion in a third example.

FIG. 12 is a schematic sectional side view of the liquid container and the ejecting head.

FIG. 13 is a schematic sectional side view illustrating a process of moving the liquid container to break the coupling of the liquid container and a supply flow path.

FIG. 14 is a schematic sectional side view of the liquid container and a collection container.

FIG. 15 is a schematic sectional side view illustrating a state in which a liquid is collected from the liquid container to the collection container.

FIG. 16 is a schematic sectional side view of a part of a liquid ejecting apparatus in a modification provided with a liquid container and an ejecting head.

FIG. 17 is a schematic sectional side view illustrating a process of detaching the liquid container from a bottom surface of the liquid ejecting apparatus.

FIG. 18 is a schematic sectional side view of a collection container in the modification.

### DESCRIPTION OF EMBODIMENTS

### First Embodiment

Hereinafter, a first embodiment of a liquid ejecting apparatus including a liquid container will be described with reference to the drawings. Note that the liquid ejecting apparatus of the present embodiment is, for example, a multifunction printer, and prints (records) characters, images, and the like on a medium such as paper by ejecting a liquid such as ink.

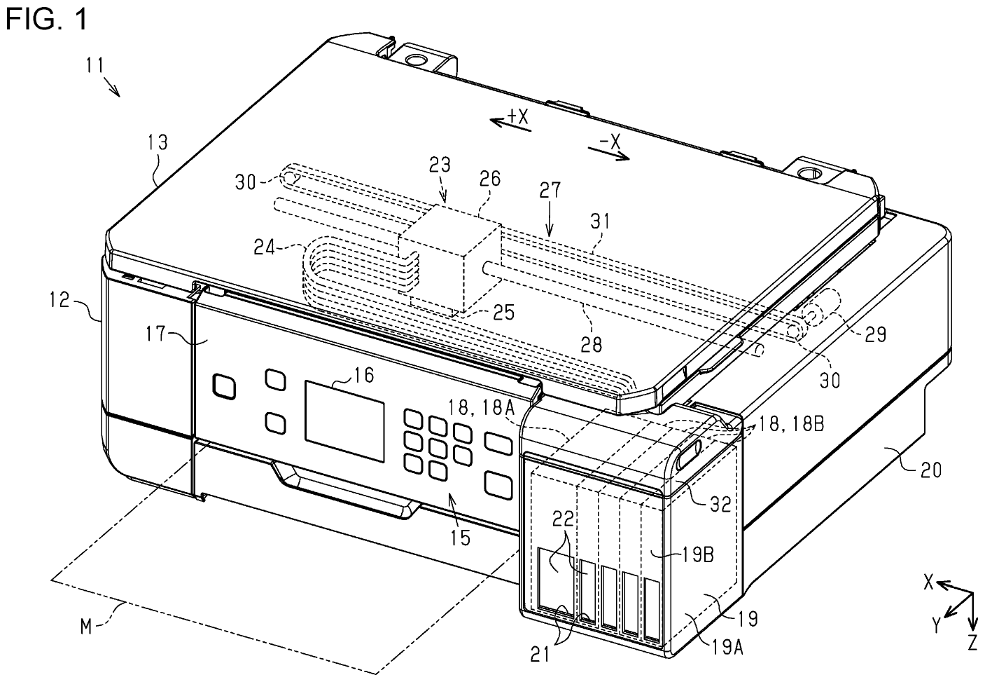

As illustrated in FIG. 1, a liquid ejecting apparatus 12, which is an example of a multifunction printer 11, includes an image reader 13 in an upper portion thereof, and has a substantially rectangular parallelepiped shape as a whole.

In FIG. 1, assuming that the multifunction printer 11 is placed on a horizontal plane, a gravity direction is denoted to illustrate as a vertical direction Z, and two directions along the horizontal plane are denoted to illustrate as a width direction X and a depth direction Y. That is, the width direction X, the depth direction Y, and the vertical direction Z intersect with (preferably, are orthogonal to) each other. In addition, one end side in the depth direction Y may be referred to as a front side, the other end side opposite to the one end side may be referred to as a rear side, one end side in the width direction X viewed from the front side may be referred to as a right side, and the other end side may be referred to as a left side.

### Configuration of Liquid Ejecting Apparatus 12

As illustrated in FIG. 1, an operation panel 17 is provided on a front surface of the liquid ejecting apparatus 12. The operation panel 17 includes an operation portion 15 such as buttons for performing various operations and a display portion 16 for displaying various kinds of information such as a menu and an operation state. Furthermore, a liquid containing unit 19 is provided on the right side of the operation panel 17. At least one (five in the present embodiment) liquid container 18 is housed in the liquid containing unit 19. The liquid containing unit 19 constitutes a part of a housing 20. The liquid container 18 is, for example, an ink tank type.

The liquid containing unit 19 includes a substantially box-shaped main body 19A which is opened upward, and a cover 32. The cover 32 covers an upper opening of the main body 19A in an openable/closable state. The main body 19A has at least one (five in the present embodiment) window portion 21 corresponding to each of liquid containers 18. A viewing surface 22 provided on a front surface of the liquid container 18 is exposed in the window portion 21. A user visually recognizes the remaining amount of liquid in the liquid container 18 through the viewing surface 22 exposed to the window portion 21. In the present embodiment, a viewing plate portion 19B, which is a plate-shaped portion having the window portion 21 and constituting a front plate portion of the main body 19A, is configured to be detachable.

As illustrated in FIG. 1, the plurality of liquid containers 18 housed in the liquid containing unit 19 includes a first liquid container 18A and a second liquid container 18B that contain different amounts of ink, and are arranged in a row in the width direction X. In the example illustrated in FIG. 1, there is one first liquid container 18A and four second liquid containers 18B. The one first liquid container 18A has a larger capacity than the second liquid container 18B, and contains, for example, black ink. The four second liquid containers 18B contain, for example, different colors of ink. The plurality of liquid containers 18 contains liquids of different colors, such as cyan, magenta, yellow, and black, as different types of liquids. The liquid may be a pigment ink or a dye ink. Further, the liquid may be a coating liquid or the like.

The first liquid container 18A and the second liquid container 18B have the same basic configuration except that widths are different because of different capacities. For this reason, when the first liquid container 18A and the second liquid container 18B are not particularly distinguished, they are simply referred to as the “liquid container 18”.

In addition, the liquid ejecting apparatus 12 includes, in the housing 20, a printing unit 23 that performs printing by attaching a liquid such as ink to a medium M, and a supply flow path 24, formed of a tube or the like, for supplying the liquid in the liquid container 18 to the printing unit 23. The printing unit 23 includes an ejecting head 25 that ejects a liquid, and a carriage 26 that holds the ejecting head 25 and can reciprocate along the width direction X (scanning direction). The printing unit 23 prints on the medium M by ejecting the liquid onto the medium M from the moving ejecting head 25.

The liquid ejecting apparatus 12 includes a moving mechanism 27 that moves the printing unit 23 in the housing 20. The moving mechanism 27 includes a guide shaft 28 that guides the carriage 26 to be movable in the width direction X, a carriage motor 29 that is a driving source, a pair of pulleys 30, an endless timing belt 31 that is wound around the pair of pulleys 30, and the like. One of the pair of pulleys 30 is fixed to an output shaft of the carriage motor 29. When the carriage motor 29 is driven to rotate forward, the printing unit 23 moves forward in a +X direction, and when the carriage motor 29 is driven to rotate backward, the printing unit 23 moves backward in a −X direction.

The liquid container 18, the supply flow path 24, the ejecting head 25, the carriage 26, the moving mechanism 27, and the like are housed in the housing 20. Multiple supply flow paths 24 are provided so as to correspond to the respective liquid containers 18. That is, the plurality of liquid containers 18 supply liquids of different colors to the printing unit 23 through the respective multiple supply flow paths 24.

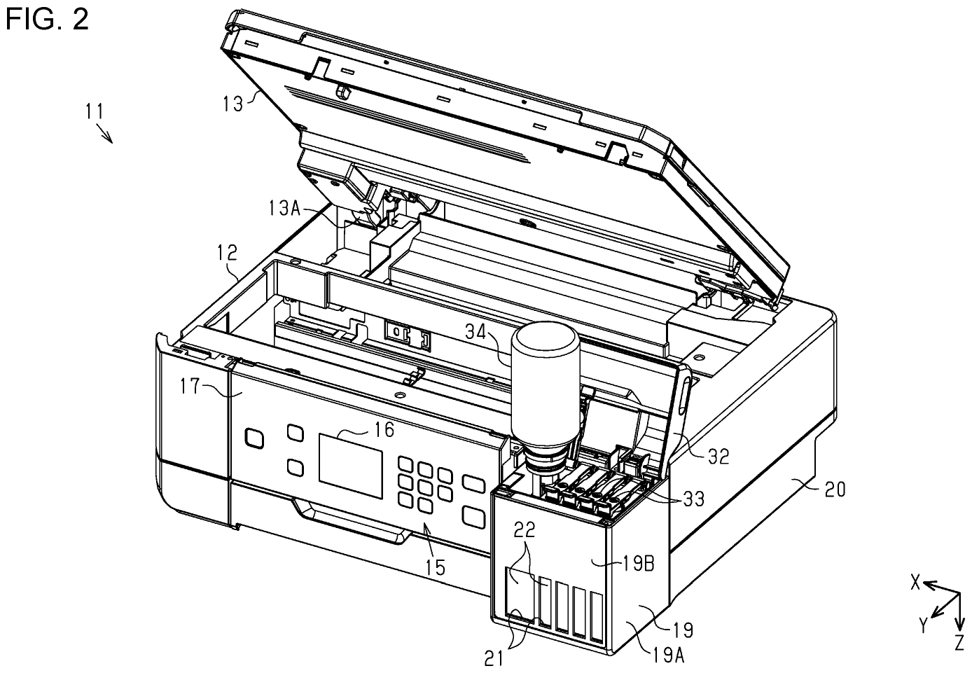

As illustrated in FIG. 2, the image reader 13 is configured to be openable/closable between a close position illustrated in FIG. 1 and an open position illustrated in FIG. 2 relative to the liquid ejecting apparatus 12 via a rotation mechanism 13A such as a hinge. When the image reader 13 is positioned at the open position, a cap lever 33 attached to the cover 32 and the liquid container 18 (see FIG. 1) can be opened/closed. When a liquid such as ink is supplied to the liquid container 18, as illustrated in FIG. 2, the image reader 13, the cover 32, and the cap lever 33 are positioned at the open position. A supplying port of a liquid bottle 34 is coupled to a liquid filling port of the liquid container 18 in an inverted posture in which the supplying port is directed downward. The cover 32 may be configured to be independently openable/closable even when the image reader 13 is in a closed state.

### Internal Configuration of Liquid Ejecting Apparatus 12

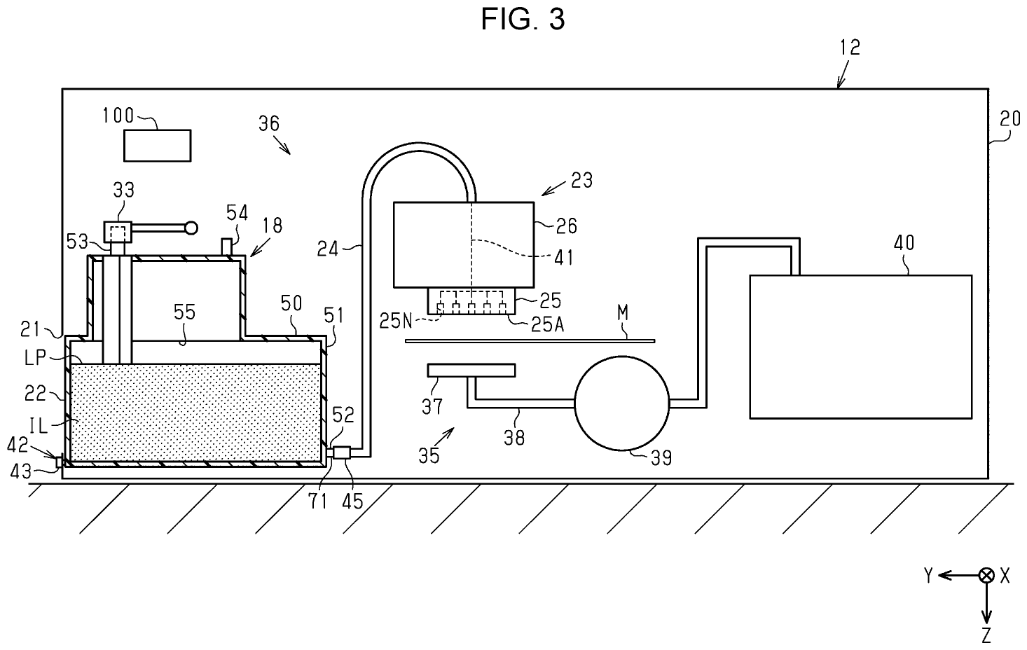

Next, an internal configuration of the liquid ejecting apparatus 12 will be described with reference to FIG. 3. As illustrated in FIG. 3, the ejecting head 25 includes a nozzle forming surface 25A in which a nozzle 25N is opened. In the example illustrated in FIG. 3, the plurality of nozzles 25N is opened in the nozzle forming surface 25A. The ejecting head 25 is configured to eject a liquid from the plurality of nozzles 25N. For example, the plurality of nozzles 25N may be provided for each type (for example, color) of liquid to be ejected.

The liquid ejecting apparatus 12 includes a maintenance device 35 that maintains the ejecting head 25 and a liquid supply device 36 that supplies a liquid from the liquid container 18 to the ejecting head 25. The maintenance device 35 includes a cap 37 that can be raised and lowered relative to the ejecting head 25 at a standby position, and a discharging tube 38 that is coupled to the cap 37. The cap 37 is configured to be movable between a retracted position illustrated in FIG. 3 where the cap 37 is separated from the ejecting head 25 and a capping position (not illustrated) where the cap 37 is in contact with the nozzle forming surface 25A of the ejecting head 25. The cap 37 can receive the liquid ejected or discharged from the nozzle 25N for maintenance.

When the cap 37 is positioned at the capping position, a closed space communicating with the nozzle 25N is formed between the cap 37 and the nozzle forming surface 25A. The maintenance device 35 includes a suction pump 39 interposed in the middle of the discharging tube 38. The maintenance device 35 drives the suction pump 39 in a state in which the ejecting head 25 is capped, and depressurizes the closed space surrounded and formed by the cap 37 and the nozzle forming surface 25A. By this depressurization, foreign substances such as air bubbles are sucked and discharged together with the liquid from the nozzle 25N of the ejecting head 25. The liquid discharged from the nozzle 25N by the cleaning is collected in a waste liquid container 40 through the cap 37 and the discharging tube 38.

As illustrated in FIG. 3, the plurality of liquid supply devices 36 is provided corresponding to the plurality of liquid containers 18, but FIG. 3 illustrates one liquid supply device 36 including one liquid container 18. Since the plurality of liquid supply devices 36 basically has the same configuration, the configuration of one liquid supply device 36 will be described below.

As illustrated in FIG. 3, the liquid supply device 36 includes the liquid container 18 and the supply flow path 24 for supplying the liquid in the liquid container 18 to the ejecting head 25. The supply flow path 24 may be an elastically deformable tube or may be formed inside a flow path forming member made of a hard resin material. In addition, the supply flow path 24 may include a portion formed by attaching a film to a flow path forming member in which a groove is formed.

An upstream end portion (one end portion) of the supply flow path 24 is coupled to the liquid container 18. A downstream end portion (the other end portion) of the supply flow path 24 is coupled to an upstream end portion of a liquid flow path 41 included in the carriage 26. The liquid in the liquid container 18 is sent to the ejecting head 25 through the supply flow path 24 and the liquid flow path 41.

The liquid container 18 includes a container main body 50. The container main body 50 is constituted of a case made of a synthetic resin. The case constituting the container main body 50 is made of a transparent or translucent resin. Therefore, a level of a liquid level of the liquid contained in a liquid containing chamber 55 can be visually recognized from the outside through the viewing surface 22 on a front surface of the container main body 50. The liquid container 18 is fixed to the liquid ejecting apparatus 12 by a fixing portion 42. The fixing portion 42 is formed of, for example, a screw 43 or the like that fixes, directly or via an attachment member (not illustrated), the liquid container 18 to a frame constituting the housing 20. The container main body 50 may have a configuration in which a film is fixed to one surface of a containing case having a containing chamber use recessed portion recessed in one surface, and the liquid containing chamber 55 is surrounded and formed by the film and the containing chamber use recessed portion.

The liquid container 18 includes a liquid containing portion 51 configured to contain a liquid, a liquid filling portion 53 through which the liquid is filled into the liquid containing portion 51, and a liquid supplying portion 52 through which the liquid in the liquid containing portion 51 is supplied. The liquid supplying portion 52 is a portion to which one end portion of the supply flow path 24 for supplying the liquid to the ejecting head 25 is coupled, and supplies the liquid in the liquid container 18. The liquid container 18 includes a liquid discharging portion 71 through which the liquid contained in the liquid containing portion 51 is discharged outside. In this embodiment, the liquid supplying portion 52 also serves as the liquid discharging portion 71. A coupling portion 45 is fixed to the upstream end portion of the supply flow path 24. The liquid supplying portion 52 communicates with the supply flow path 24 by being coupled to the coupling portion 45.

As illustrated in FIG. 3, at least a part of the liquid container 18 is positioned below the ejecting head 25. That is, the ejecting head 25 is positioned above a liquid level LP in the liquid container 18 in the vertical direction Z. Specifically, an opening of the nozzle 25N is positioned higher than the position when the liquid level LP in the liquid container 18 is at the maximum height. Any positional relationship of the ejecting head 25 and the liquid container 18 in the vertical direction Z is allowed as long as a meniscus of the liquid is formed in the nozzle 25N and the liquid does not drip from the nozzle 25N.

The liquid ejecting apparatus 12 illustrated in FIG. 3 includes a control unit 100 that controls the entire operation of the multifunction printer 11. The control unit 100 controls the carriage motor 29 that causes the carriage 26 to reciprocate, a transport unit (not illustrated) that transports the medium M, an ejecting operation of the ejecting head 25, a cleaning operation of the maintenance device 35, and the like.

### Configuration of Liquid Container 18

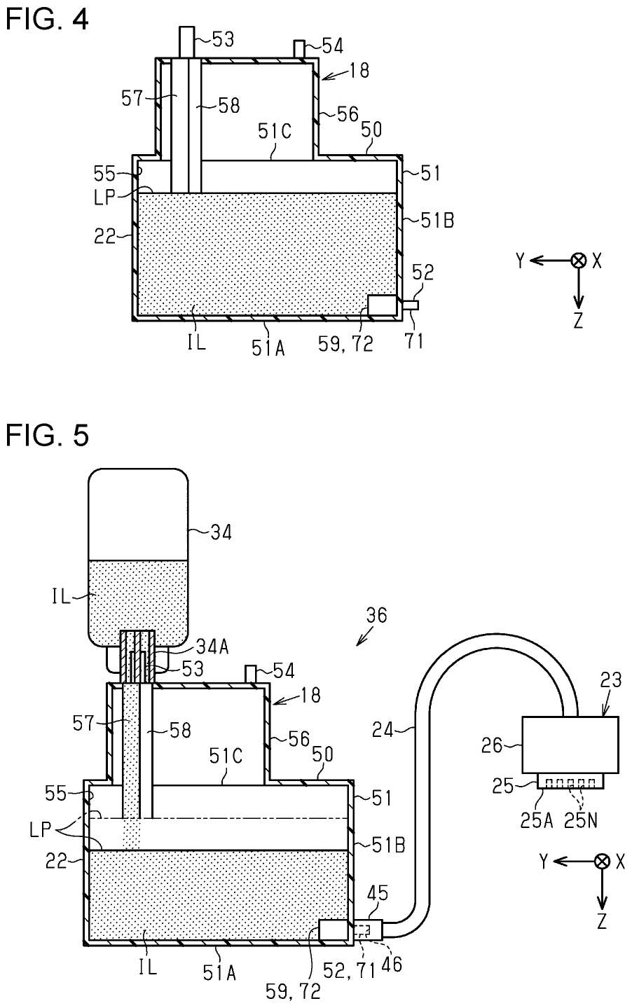

Next, a configuration of the liquid container 18 will be described with reference to FIG. 4. Note that the first liquid container 18A and the second liquid container 18B have different widths because of the difference in capacities, but have the same basic configuration. Therefore, hereinafter, the first liquid container 18A and the second liquid container 18B will be described as the liquid container 18 without being particularly distinguished from each other.

As illustrated in FIGS. 4 and 5, the container main body 50 includes the liquid containing portion 51 having the liquid containing chamber 55 and a protruding portion 56 protruding upward from the liquid containing portion 51. The container main body 50 includes the liquid supplying portion 52, the liquid filling portion 53, and an air communication portion 54 as tubular portions protruding outward. The liquid supplying portion 52, the liquid filling portion 53, and the air communication portion 54 communicate with the liquid containing chamber 55. A liquid IL is contained in the liquid containing chamber 55.

The liquid filling portion 53 is used to fill a liquid such as ink into the liquid containing chamber 55. The liquid filling portion 53 and the liquid containing chamber 55 are coupled to each other via a liquid flow path 57 and an air flow path 58. The liquid filling portion 53 communicates with both the liquid flow path 57 and the air flow path 58. End portions (lower ends) of the liquid flow path 57 and the air flow path 58 on the liquid containing chamber 55 side are positioned at the maximum liquid level height.

The air communication portion 54 makes an air area above the liquid level LP in the liquid containing chamber 55 communicate with the air. The container main body 50 includes a partition wall portion 51C that internally partitions the liquid containing portion 51 and the protruding portion 56. The communication path between the liquid containing chamber 55 and the air communication portion 54 includes a fine hole in which a part thereof is thin and meandering. Therefore, the liquid containing chamber 55 communicates with the air communication portion 54 in a state in which the water content of the liquid stored in the liquid containing chamber 55 is unlikely to evaporate.

As illustrated in FIG. 5, when the liquid is filled into the liquid container 18, a supplying portion 34A is coupled to the liquid filling portion 53 with the liquid bottle 34 in an inverted posture. The inside of the liquid bottle 34 coupled to the liquid filling portion 53 communicates with the liquid containing chamber 55 through both the liquid flow path 57 and the air flow path 58. Therefore, while the liquid in the liquid bottle 34 is filled into the liquid container 18 through the liquid flow path 57, the air in the liquid containing chamber 55 is sent into the liquid bottle 34 through the air flow path 58. By this gas-liquid exchange, the filling of the liquid from the liquid bottle 34 into the liquid containing chamber 55 is continuously performed until the liquid level LP reaches the lower end of the air flow path 58. Then, when the liquid level LP reaches the lower end of the air flow path 58, the gas-liquid exchange is not performed, and thus the filling of the liquid from the liquid bottle 34 into the liquid containing chamber 55 stops. In this way, when the liquid level LP reaches the highest liquid level, the filling of the liquid into the liquid container 18 stops. When the liquid is filled from the liquid bottle 34 into the liquid container 18, the air in the liquid containing chamber 55 is discharged from the air communication portion 54.

As illustrated in FIGS. 4 and 5, in the liquid container 18 of the first embodiment, the liquid supplying portion 52 also serves as the liquid discharging portion 71. The liquid discharging portion 71 is disposed at a bottom surface 51A or a lower portion of a side surface 51B of the liquid containing portion 51. For this reason, the liquid supplying portion 52 that also serves as the liquid discharging portion 71 is disposed at the bottom surface 51A or the lower portion of the side surface 51B of the liquid containing portion 51. In the example illustrated in FIGS. 4 and 5, the liquid supplying portion 52 that also serves as the liquid discharging portion 71 is disposed at the lower portion of the side surface 51B of the liquid containing portion 51.

Here, the lower portion of the side surface 51B may be, for example, a portion having a height equal to or lower than half the maximum liquid level height in the liquid containing portion 51. As a matter of course, when the liquid discharging portion 71 is positioned at a height as low as possible in the liquid containing chamber 55, a larger amount of liquid can be discharged by using water head pressure between the liquid level in the liquid containing portion 51 and a discharging port of the liquid discharging portion 71. However, a small amount of the liquid remaining in the liquid containing portion 51 can also be discharged by tilting the liquid container 18. Therefore, when half or more of the liquid remains in the liquid containing portion 51, the liquid discharging portion 71 may be positioned at a height at which at least a part of the liquid can be discharged using the water head pressure.

As illustrated in FIGS. 4 and 5, a bottom surface of the liquid containing chamber 55 is inclined so that the height decreases toward the position opposite to the viewing surface 22 in the depth direction Y. For this reason, the liquid in the liquid container 18 is easily supplied outside from the liquid supplying portion 52 to the end. The liquid containing chamber 55 may be partitioned into a plurality of compartments communicating with each other by a plurality of ribs (not illustrated). In this case, for example, when the liquid ejecting apparatus 12 is transported, shaking or the like of the liquid in the liquid containing chamber 55 is suppressed, and such as mixing of air (bubbles) into the liquid due to bubbling or the like caused by shaking or the like is suppressed.

By coupling the liquid supplying portion 52 to the coupling portion 45, the liquid supplying portion 52 is coupled to a coupling port 46 of the coupling portion 45. The liquid supplying portion 52 in the liquid container 18 includes a first valve 59 that can open/close a flow path through which the liquid is supplied. In other words, in the first embodiment in which the liquid supplying portion 52 also serves as the liquid discharging portion 71, the liquid discharging portion 71 includes a second valve 72 that can open/close the flow path through which the liquid is discharged. Here, the liquid supplying portion 52 is a portion having a discharging port through which the liquid in the liquid container 18 is supplied to the ejecting head 25. On the other hand, the liquid discharging portion 71 is a portion having a discharging port through which the liquid remaining in the liquid container 18 is discharged outside when the liquid ejecting apparatus 12 is discarded or the like. Both the liquid supplying portion 52 and the liquid discharging portion 71 have a function of discharging the liquid in the liquid container 18, although there is a difference in whether the discharge destination is the ejecting head 25 or the outside. Therefore, the liquid supplying portion 52 and the liquid discharging portion 71 can be used in common.

The first valve 59 is in a valve closed state in a non-coupling state illustrated in FIG. 4 in which the first valve 59 is not coupled to the coupling portion 45 fixed to the upstream end portion of the supply flow path 24. On the other hand, the first valve 59 is in a valve open state open state in a coupling state illustrated in FIG. 5 in which the first valve 59 is coupled to the coupling portion 45 of the supply flow path 24. The first valve 59 is configured to automatically switch between opening and closing in accordance with the presence or absence of coupling of the liquid supplying portion 52 and the coupling portion 45.

The first valve 59 may have, for example, the following structure. The liquid supplying portion 52 is urged by an urging member (not illustrated) in a direction in which the liquid supplying portion 52 advances outward in a state in which the liquid supplying portion 52 can advance and retreat in an axial direction of the liquid supplying portion 52. For example, when the coupling portion 45 is coupled to the liquid supplying portion 52, the liquid supplying portion 52 retreats because of a force received from the coupling portion 45, and thus the first valve 59 is switched from the valve closed state to the valve open state. In addition, when the coupling portion 45 is detached from the liquid supplying portion 52, the liquid supplying portion 52 is restored in an advancing direction by the urging force of the urging member, and thus the first valve 59 is switched from the valve open state to the valve closed state. Therefore, it is possible to attach and detach the coupling portion 45 to and from the liquid supplying portion 52 while suppressing leakage of the liquid.

When the liquid ejecting apparatus 12 is discarded, the first valve 59 also functions as the second valve 72. The second valve 72 has a function of opening/closing a discharge flow path of the liquid discharging portion 71 when the liquid in the liquid container 18 is discharged outside other than the ejecting head 25. The second valve 72 may have, for example, the following structure. The liquid discharging portion 71 is urged by an urging member (not illustrated) in a direction in which the liquid discharging portion 71 advances outward in a state in which the liquid discharging portion 71 can advance and retreat in an axial direction of the liquid discharging portion 71. For example, when a collection coupling portion 62 of a collection container 60, which will be described later, is coupled to the liquid discharging portion 71, the liquid discharging portion 71 retreats because of a force received from the collection coupling portion 62, and thus the second valve 72 is switched from the valve closed state to the valve open state. In addition, when the collection coupling portion 62 is detached from the liquid discharging portion 71, the second valve 72 is switched from the valve open state to the valve closed state because of the collection coupling portion 62 being restored in the advancing direction by the urging force of the urging member. Therefore, it is possible to attach and detach the collection coupling portion 62 to and from the liquid discharging portion 71 while suppressing leakage of the liquid.

### For Collection of Liquid in Liquid Container 18

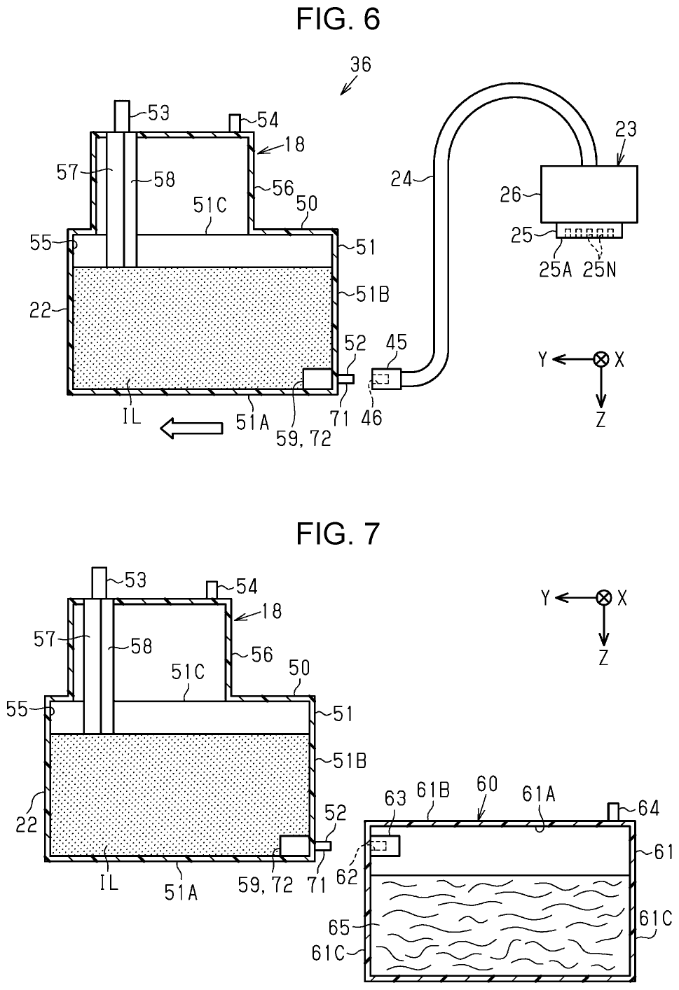

Next, a configuration and a process for collecting the liquid in the liquid container 18 will be described with reference to FIGS. 6 to 8.

In the first embodiment, the liquid container 18 is configured to be pulled out from the housing 20 of the liquid ejecting apparatus 12 along a coupling direction of the liquid supplying portion 52 and the supply flow path 24. As described above, since the viewing plate portion 19B (see FIG. 1) constituting a front surface portion of the liquid containing unit 19 is detachable, after the viewing plate portion 19B is detached by being slid upward or in the width direction X, as illustrated in FIG. 6, the liquid container 18 is moved in a first direction indicated by a white arrow, which is a coupling direction of the liquid supplying portion 52 and the coupling portion 45. By the movement of the liquid container 18 in the first direction, the coupling portion 45 is detached from the liquid supplying portion 52. At this time, the first valve 59 is switched from the valve open state to the valve closed state. Therefore, as illustrated in FIG. 6, even when the liquid supplying portion 52 is exposed, the leakage of liquid from the liquid supplying portion 52 is suppressed. The liquid in the detached liquid container 18 is collected in the collection container 60 illustrated in FIG. 7, for example.

### Configuration of Collection Container 60

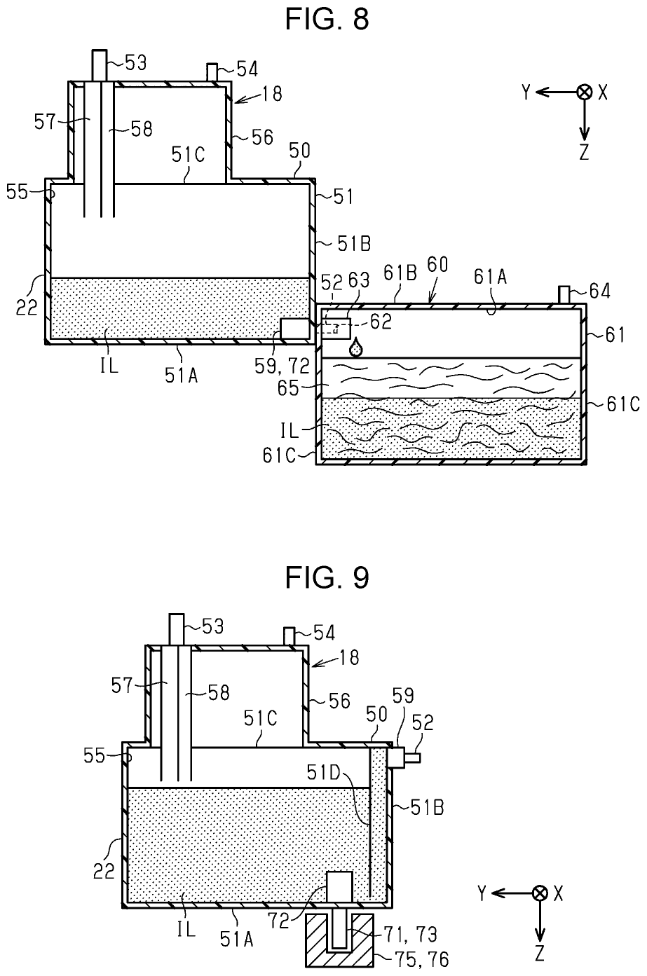

Next, the configuration of the collection container 60 will be described with reference to FIGS. 7 and 8.

The collection container 60 illustrated in FIG. 7 is prepared by a user, for example, when the liquid ejecting apparatus 12 is discarded. The collection container 60 includes a collection containing portion 61 that contains the liquid discharged from the liquid discharging portion 71 of the liquid container 18, and the collection coupling portion 62 configured to be coupled to the liquid discharging portion 71. The collection container 60 collects the liquid remaining in the liquid container 18 through coupling of the liquid discharging portion 71 and the collection coupling portion 62. The collection coupling portion 62 is positioned at an upper surface 61B or an upper portion of a side surface 61C of the collection containing portion 61. In the example illustrated in FIG. 7, the collection coupling portion 62 is positioned at the upper portion of the side surface 61C of the collection containing portion 61. The collection containing portion 61 includes a collection containing chamber 61A.

The collection container 60 may include a third valve 63 that opens/closes a flow path through which the collection coupling portion 62 collects the liquid. For example, the third valve 63 is in the valve closed state in a non-coupling state illustrated in FIG. 7 in which the collection coupling portion 62 is not coupled to the liquid discharging portion 71 on the liquid container 18 side. On the other hand, the third valve 63 is in the valve open state in a coupling state illustrated in FIG. 8 in which the collection coupling portion 62 is coupled to the liquid discharging portion 71. In this manner, the third valve 63 may be configured to automatically switch between opening and closing in accordance with the presence or absence of the coupling of the liquid discharging portion 71 and the collection coupling portion 62.

For example, when the liquid discharging portion 71 is coupled to the collection coupling portion 62, there is a portion which is displaced against the urging force of the urging member on the collection coupling portion 62 side, and the third valve 63 is switched from the valve closed state to the valve open state by this displacement. In addition, when the liquid discharging portion 71 is detached from the collection coupling portion 62, the portion on the collection coupling portion 62 side is restored to the original position by the urging member, and thus the third valve 63 is switched from the valve open state to the valve closed state.

In addition, as illustrated in FIG. 7, the collection container 60 includes an air communication portion 64. The air communication portion 64 makes the collection containing chamber 61A communicate with the outside. The air communication portion 64 makes the collection containing chamber 61A communicate with the outside via an air communication path including a fine hole portion formed by a meandering path.

As illustrated in FIG. 8, when the liquid discharging portion 71 of the liquid container 18 and the collection coupling portion 62 of the collection container 60 are coupled, the liquid in the liquid container 18 moves to the collection container 60 because of the water head pressure. That is, in a state in which the liquid discharging portion 71 of the liquid container 18 and the collection coupling portion 62 of the collection container 60 are coupled, an inner bottom surface of the liquid containing chamber 55 in the liquid container 18 is set to be positioned higher than the maximum liquid level height when the maximum amount of liquid is collected in the collection containing chamber 61A of the collection container 60. Here, the maximum amount of liquid is a maximum amount of liquid that can be contained in the liquid container 18.

In addition, in a state in which the liquid discharging portion 71 and the collection coupling portion 62 are coupled, an amount of air corresponding to the volume of the liquid which flows into the collection container 60 from the liquid container 18 is discharged from the air communication portion 64, and thus the liquid continuously flows into the collection container 60 from the liquid container 18. Since the volume of the collection container 60 is larger than the maximum amount of liquid that can be contained in the liquid container 18, the liquid does not spill on the collection container 60 side.

In addition, as illustrated in FIGS. 7 and 8, the collection container 60 may have a liquid holding member 65 capable of holding the liquid in the collection containing portion 61. The liquid holding member 65 is a liquid absorbing member capable of holding a liquid by absorbing the liquid. The liquid holding member 65 may be, for example, a nonwoven fabric. The liquid holding member may be a liquid absorbing member made of a sponge or a porous material. The liquid holding member 65 is housed in the collection containing chamber 61A with a volume capable of holding an amount of liquid corresponding to the maximum volume of the liquid contained in the liquid container 18. The liquid inside the collection container 60 is held by the liquid holding member 65, so that the liquid does not leak even when the collection container 60 is inclined. In the present embodiment, the collection container 60 and the liquid ejecting apparatus 12 may constitute a liquid ejecting system.

### Action of First Embodiment

Next, the action of the liquid ejecting apparatus 12 including the liquid container 18 according to the first embodiment will be described. The action of the liquid ejecting system including the liquid ejecting apparatus 12 and the collection container 60 will also be described.

When the liquid ejecting apparatus 12 is discarded, a user obtains the collection container 60. The collection container 60 may be packed together with the liquid ejecting apparatus 12 when the liquid ejecting apparatus 12 is purchased, or a user may obtain the collection container 60 from a manufacturer, a dealer, or the like when the liquid ejecting apparatus 12 is discarded. The collection container 60 may be charged or free of charge.

As illustrated in FIG. 2, a user opens the image reader 13 and the cover 32 in the liquid ejecting apparatus 12 illustrated in FIG. 1. Further, the user detaches the viewing plate portion 19B from the housing 20 by sliding the viewing plate portion 19B constituting the front surface portion of the liquid containing unit 19 upward or in the width direction X. By detaching the viewing plate portion 19B, the front side (+Y direction side) of the liquid container 18 is opened. Therefore, the liquid container 18 can be slid in the first direction (+Y direction).

As illustrated in FIG. 6, the user moves the liquid container 18 in the first direction indicated by the white arrow in FIG. 6 by sliding, for example. The first direction is the coupling direction of the liquid supplying portion 52 and the supply flow path 24. In particular, in the present example, since the supply flow path 24 includes the coupling portion 45 at the upstream end portion thereof, the first direction is the coupling direction of the liquid supplying portion 52 and the coupling portion 45. The first direction in which the user moves the liquid container 18 may be a direction along the coupling direction of the liquid supplying portion 52 and the supply flow path 24 or the coupling portion 45. The first direction may be a direction intersecting with the coupling direction of the liquid supplying portion 52 and the supply flow path 24 or the coupling portion 45, for example, with a range of 0<θ≤20°. In short, when the user moves the liquid container 18 in the first direction, the liquid supplying portion 52 may remove the coupling to the supply flow path 24 or the coupling portion 45 to be detached from the supply flow path 24 or the coupling portion 45 without applying an excessive load to the liquid supplying portion 52 and the supply flow path 24 or the coupling portion 45.

Even when the coupling portion 45 is detached from the liquid supplying portion 52, the first valve 59 is switched from the valve open state to the valve closed state, and thus the leakage of liquid such as ink from the liquid supplying portion 52 is suppressed. Therefore, the inside of the housing 20 is prevented from being contaminated by a liquid such as ink as much as possible. When the coupling portion 45 is detached from the liquid supplying portion 52, a valve (not illustrated) provided on the coupling portion 45 side is switched from the valve open state to the valve closed state. Therefore, the leakage of liquid such as ink from the coupling portion 45 is also suppressed.

Next, the liquid discharging portion 71 of the liquid container 18 detached from the housing 20 is coupled to the collection coupling portion 62 of the collection container 60. Then, both the second valve 72 (the same valve as the first valve 59 in the present embodiment) and the third valve 63 are switched from the valve closed state to the valve open state. The liquid in the liquid container 18 is moved to the collection container 60 by the water head pressure. In this liquid collection process, the amount of air corresponding to the volume of the liquid that has flowed into the collection container 60 from the liquid container 18 is discharged from the air communication portion 64. Accordingly, the liquid continuously flows into the collection container 60 from the liquid container 18. Since the capacity of the collection container 60 is larger than the maximum amount of liquid of the liquid that can be contained in the liquid container 18, the collection container 60 can collect the liquid without spilling. The liquid collected in the collection container 60 is absorbed by the liquid holding member 65. Since the liquid collected in the collection container 60 is held by the liquid holding member 65, the liquid does not leak even when the collection container 60 is inclined. Then, the user discards the liquid ejecting apparatus 12 after removing the liquid remaining in the liquid container 18.

Therefore, according to the first embodiment, the following effects can be obtained.
(1-1) The liquid ejecting apparatus 12 includes the ejecting head 25 that ejects a liquid and the liquid container 18 that can contain a liquid to be supplied to the ejecting head 25. The liquid container 18 includes the liquid containing portion 51 configured to contain a liquid and the liquid filling portion 53 through which a liquid is filled into the liquid containing portion 51. Further, the liquid container 18 includes the liquid supplying portion 52 to which one end portion of the supply flow path 24 for supplying the liquid to the ejecting head 25 is coupled and through which the liquid in the liquid containing portion 51 is supplied, and the liquid discharging portion 71 through which the liquid contained in the liquid containing portion 51 is discharged outside. The liquid discharging portion 71 is disposed at the bottom surface 51A or the lower portion of the side surface 51B of the liquid containing portion 51. With the use of this configuration, the liquid ejecting apparatus 12 can discharge the liquid remaining in the liquid container 18 outside through the liquid discharging portion 71 which is disposed at the bottom surface 51A or the lower portion of the side surface 51B of the liquid containing portion 51. Therefore, it is possible to discard the liquid ejecting apparatus 12 after discharging the liquid remaining in the liquid container 18 outside. The liquid supplying portion 52 may also serve as the liquid discharging portion 71.
(1-2) The liquid supplying portion 52 also serves as the liquid discharging portion 71. With the use of this configuration, since the liquid supplying portion 52 also serves as the liquid discharging portion 71, a simple configuration is sufficient.
(1-3) The liquid supplying portion 52 and the liquid discharging portion 71 are separate from each other. With the use of this configuration, since the liquid supplying portion 52 and the liquid discharging portion 71 are separate from each other, the degree of freedom in selecting an arrangement position of each of the liquid supplying portion 52 and the liquid discharging portion 71 in the liquid containing portion 51 is increased. Therefore, the liquid supplying portion 52 and the liquid discharging portion 71 can be disposed at appropriate positions in the liquid containing portion 51.
(1-4) The liquid supplying portion 52 includes the first valve 59 that can open/close the flow path through which the liquid is supplied. With the use of this configuration, supply/non-supply of the liquid via the liquid supplying portion 52 can be selected by the first valve 59. For example, the first valve 59 opens when the liquid supplying portion 52 is coupled to a coupling target such as a flow path for supplying a liquid to the ejecting head 25, and the first valve 59 closes when the coupling to the coupling target is released. Thus, it is possible to appropriately supply the liquid to the ejecting head 25 while preventing the liquid leakage from the liquid supplying portion 52.
(1-5) The liquid discharging portion 71 includes the second valve 72 that can open/close the flow path through which the liquid is discharged. With the use of this configuration, discharge/non-discharge of the liquid via the liquid discharging portion 71 can be selected by the valve. For example, the second valve 72 opens when the liquid discharging portion 71 is coupled to a coupling target such as a collection container, and the second valve 72 closes when the coupling to the coupling target is released. Thus, it is possible to appropriately discharge the liquid outside while preventing the liquid leakage from the liquid discharging portion 71.
(1-6) The liquid container 18 may be fixed to the liquid ejecting apparatus 12 by the fixing portion 42. With the use of this configuration, since the liquid container 18 is fixed to the liquid ejecting apparatus 12 by the fixing portion 42, it is easy to prevent the one end portion of the supply flow path from coming off from the liquid supplying portion 52 of the liquid container 18.

### Second Embodiment

Next, the configurations of a liquid container 18 and a collection container 60 according to the second embodiment will be described with reference to FIGS. 9 to 15. The basic configuration of a liquid ejecting apparatus 12 is the same as that of the first embodiment. Therefore, hereinafter, as for the configuration of the liquid ejecting apparatus 12, a detailed description will be omitted while denoting the same reference signs as those in the first embodiment. In particular, the configurations of the liquid container 18 and the collection container 60 will mainly be described. In the liquid container 18 and the collection container 60, the same reference signs are given to the same components as those in the first embodiment, and the detailed description thereof will be omitted.

As illustrated in FIGS. 9 to 12, the liquid container 18 of the second embodiment has a configuration in which a liquid supplying portion 52 and a liquid discharging portion 71 are separate from each other. That is, this is an example in which the liquid discharging portion 71 for discharging the liquid in the liquid container 18 outside is provided separately from the liquid supplying portion 52.

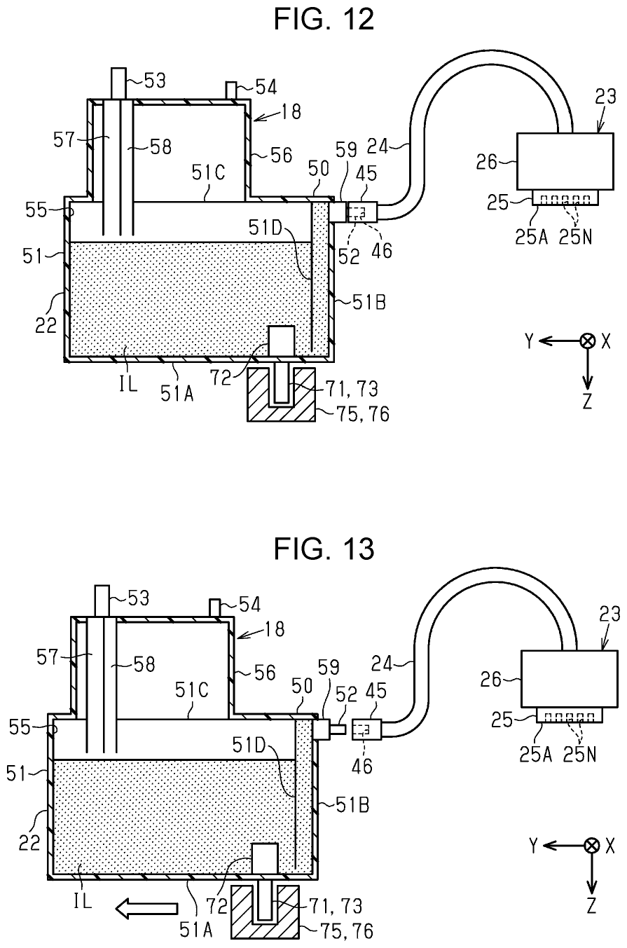

As illustrated in FIGS. 9 to 12, the basic configuration of the liquid container 18 is the same as that of the first embodiment. That is, as illustrated in FIGS. 9 to 12, the liquid container 18 includes a liquid containing portion 51 configured to contain a liquid and a liquid filling portion 53 through which the liquid is filled into the liquid containing portion 51. Further, the liquid container 18 includes the liquid supplying portion 52 to which one end portion of a supply flow path 24 (refer to FIG. 12) for supplying a liquid to an ejecting head 25 is coupled and through which the liquid in the liquid containing portion 51 is supplied, and the liquid discharging portion 71 through which the liquid contained in the liquid containing portion 51 is discharged outside. The liquid supplying portion 52 is positioned at an upper portion of a side surface 51B of the liquid container 18. The inside of a liquid containing chamber 55 of the liquid containing portion 51 is partitioned into a region in which the liquid is contained and a supply flow path that guides the liquid to the liquid supplying portion 52, by a flow path forming wall 51D that extends downward from a partition wall portion 51C.

The liquid supplying portion 52 is configured to be coupled to the coupling portion 45 provided at an upstream end portion of the supply flow path 24. When the liquid supplying portion 52 is coupled to the coupling portion 45 (see FIG. 12), the liquid supplying portion 52 is coupled to the coupling port 46 of the coupling portion 45. The liquid discharging portion 71 is disposed at a bottom surface 51A or a lower portion of a side surface 51B of the liquid containing portion 51. In the example illustrated in FIGS. 9 to 12, the liquid discharging portion 71 is disposed at the bottom surface 51A of the liquid containing portion 51. The liquid discharging portion 71 protrudes downward from the bottom surface 51A of the liquid containing portion 51.

In addition, the liquid supplying portion 52 includes a first valve 59 that can open/close a flow path through which the liquid is supplied. The liquid discharging portion 71 includes a second valve 72 that can open/close a flow path through which the liquid is discharged. In the second embodiment, since the liquid supplying portion 52 and the liquid discharging portion 71 are separate from each other, the first valve 59 and the second valve 72 are also separate from each other. The valve structure and function of the first valve 59 and the valve structure and function of the second valve 72 are the same as those of the first embodiment.

### Sealing Structure Example

Next, a configuration of a discharge coupling structure portion 75 will be described with reference to FIGS. 9 to 11. The liquid discharging portion 71 of the liquid container 18 is configured to be coupled to a coupling target separate from the liquid container 18. The liquid container 18 includes the discharge coupling structure portion 75 configured to switch between a state in which the liquid is not discharged from the liquid discharging portion 71 when the liquid discharging portion 71 is not coupled to the coupling target, and a state in which the liquid is to be discharged from the liquid discharging portion 71 when the liquid discharging portion 71 is coupled to the coupling target.

Hereinafter, three examples of the liquid container 18 having the discharge coupling structure portion 75 will be described in order with reference to FIGS. 9 to 11.

### First Example

In the liquid container 18 in the first example illustrated in FIG. 9, the discharge coupling structure portion 75 has a sealing structure that is detachably attached to the liquid discharging portion 71 and that seals the liquid discharging portion 71 by being attached to the liquid discharging portion 71 when the liquid discharging portion 71 is not coupled to the coupling target.

As illustrated in FIG. 9, the discharge coupling structure portion 75 in the first example includes a sealing member 76 that seals the liquid discharging portion 71 by being fitted to the liquid discharging portion 71 when the liquid discharging portion 71 is not coupled to the coupling target. The sealing member 76 is, for example, a plug member (cap member). The sealing member 76 is configured to be coupled to the liquid discharging portion 71, for example, by fitting or screwing.

In the example of FIG. 9, the liquid discharging portion 71 is formed of a pipe portion 73 and has a protruding shape. For this reason, the sealing member 76 has a recessed shape that is fitted to the liquid discharging portion 71 having a protruding shape. The sealing member 76 has a recessed portion having substantially the same inside diameter as the outer diameter of the protruding second discharging portion. The liquid discharging portion 71 is sealed by the sealing member 76 coupled to the liquid discharging portion 71 when the liquid discharging portion 71 is not coupled to a collection coupling portion 62 of the collection container 60 that is the coupling target. That is, in a normal use state other than when the liquid ejecting apparatus 12 is discarded or the like, the sealing member 76 seals the liquid discharging portion 71 so that the liquid in the liquid container 18 is not discharged from the liquid discharging portion 71. On the other hand, when the liquid discharging portion 71 is coupled to the collection coupling portion 62 that is the coupling target, the sealing member 76 is switched by a user from a coupling state in which the sealing member 76 is coupled to the liquid discharging portion 71 to a non-coupling state in which the sealing member 76 is not coupled to the liquid discharging portion 71. That is, the sealing member 76 is detached from the liquid discharging portion 71 by the user.

### Second Example

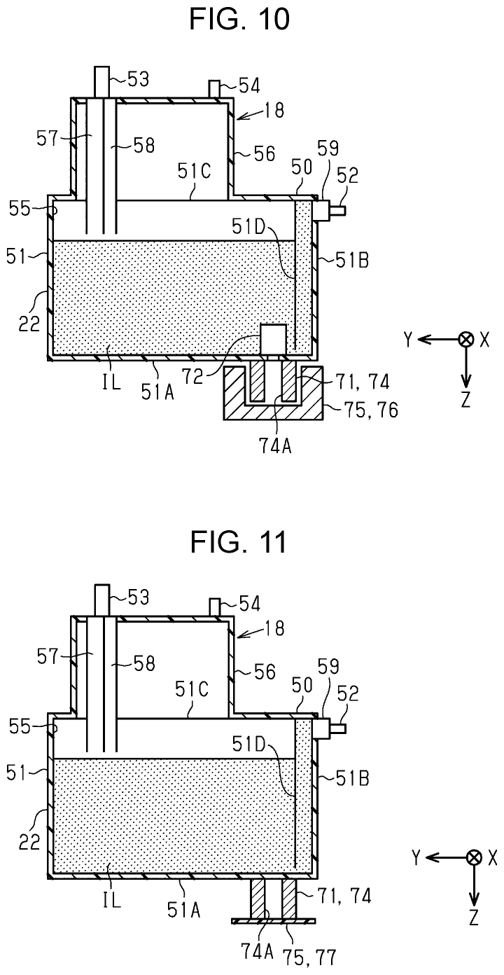

In the liquid container 18 in the second example illustrated in FIG. 10, the discharge coupling structure portion 75 is the sealing member 76 formed of a plug member (cap member) similar to that illustrated in FIG. 9. When the collection coupling portion 62 of the collection container 60 that is the coupling target has a tubular protruding shape, the liquid discharging portion 71 of the example illustrated in FIG. 10 has a recessed shape that can be coupled to the protruding shape. That is, the liquid discharging portion 71 has a cylindrical shape having a recessed portion 74A into which the collection coupling portion 62 having a tubular protruding shape is fitted. For this reason, the sealing member 76 has a recessed shape that is fitted to the liquid discharging portion 71 having a recessed shape from the outside. The sealing member 76 has a recessed portion having an inside diameter that is substantially the same as or slightly larger than the outer diameter of the liquid discharging portion 71 having the recessed shape. For this reason, when the liquid discharging portion 71 is not coupled to the collection coupling portion 62 of the collection container 60 that is the coupling target, the liquid discharging portion 71 is sealed by the sealing member 76 that is coupled to the liquid discharging portion 71. Note that the sealing member 76 in the first example and the second example can repeatedly be used even after the liquid discharging portion 71 is coupled to the coupling target.

### Third Example

In the liquid container 18 of the third example illustrated in FIG. 11, the discharge coupling structure portion 75 has a sealing structure that can be broken when a coupling target is coupled. The discharge coupling structure portion 75 in the third example is a breakable sealing member 77 attached to the liquid discharging portion 71. The sealing member 77 is, for example, a sealing film. When the liquid discharging portion 71 is not coupled to the collection coupling portion 62 of the collection container 60 that is the coupling target, the liquid discharging portion 71 is sealed by the sealing member 77 coupled to the liquid discharging portion 71. That is, in a normal use state other than when the liquid ejecting apparatus 12 is discarded or the like, the sealing member 76 seals the liquid discharging portion 71 so that the liquid in the liquid container 18 is not discharged from the liquid discharging portion 71. On the other hand, when the liquid discharging portion 71 is coupled to the collection coupling portion 62 that is the coupling target, the coupling target destroys the sealing member 77. In addition, since the sealing member 77 in the third example is destroyed when the liquid discharging portion 71 is coupled to the coupling target, the sealing member 77 cannot repeatedly be used and is used only once.

### Action of Second Embodiment

Next, the action of the liquid ejecting apparatus 12 including the liquid container 18 according to the second embodiment will be described. The action of the liquid ejecting system including the liquid ejecting apparatus 12 and the collection container 60 will also be described.

When the liquid ejecting apparatus 12 is discarded, a user obtains the collection container 60. As in the first embodiment, the user moves the liquid container 18 in the first direction indicated by a white arrow in FIG. 13 by sliding, for example. The first direction is a coupling direction of the liquid supplying portion 52 and the supply flow path 24. In particular, in the present example, the first direction is the coupling direction of the liquid supplying portion 52 and the coupling portion 45.

Even when the coupling portion 45 is detached from the liquid supplying portion 52, the first valve 59 is switched from the valve open state to the valve closed state, and thus the leakage of liquid such as ink from the liquid supplying portion 52 is suppressed. Therefore, the inside of the housing 20 is prevented from being contaminated by the liquid such as ink as much as possible. When the coupling portion 45 is detached from the liquid supplying portion 52, a valve (not illustrated) provided on the coupling portion 45 side is switched from the valve open state to the valve closed state.

The liquid discharging portion 71 of the liquid container 18 detached from the housing 20 has the discharge coupling structure portion 75. The discharge coupling structure portion 75 switches between a state in which the liquid is not discharged when the discharge coupling structure portion 75 is not coupled to the collection coupling portion 62 of the collection container 60 that is an example of the coupling target, and a state in which the liquid is to be discharged when the discharge coupling structure portion 75 is coupled to the collection coupling portion 62 that is an example of the coupling target. When the discharge coupling structure portion 75 is the sealing member 76 in the first example (FIG. 9) or the sealing member 76 in the second example (FIG. 10), the user detaches the sealing member 76 from the liquid discharging portion 71 before coupling the liquid discharging portion 71 to the collection coupling portion 62. On the other hand, when the discharge coupling structure portion 75 is the sealing member 77 (FIG. 11) formed of the film member in the third example, the user couples the liquid discharging portion 71 to the collection coupling portion 62 as it is.

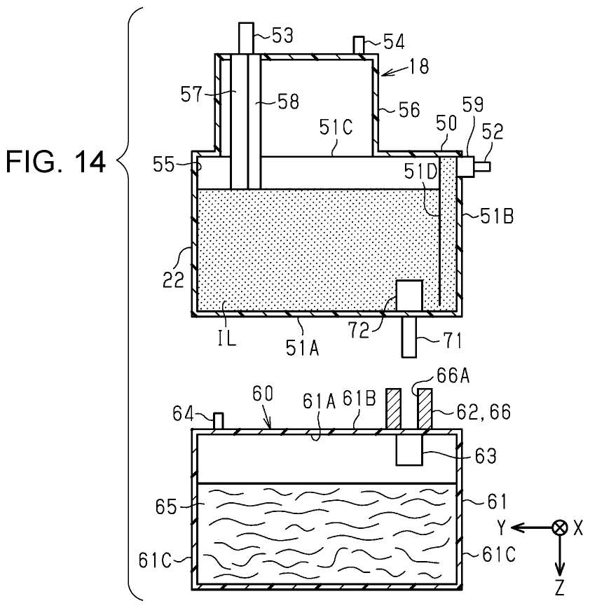

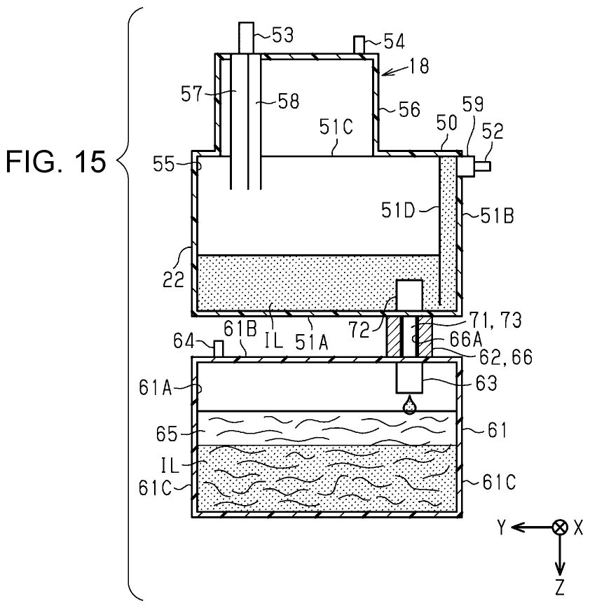

Next, as illustrated in FIG. 14, the collection container 60 is disposed on a lower side of the liquid container 18 detached from the housing 20. The collection coupling portion 62 has a cylindrical shape, and has a recessed portion 66A into which the liquid discharging portion 71 can be fitted. Then, as illustrated in FIG. 15, the liquid discharging portion 71 of the liquid container 18 is coupled to the collection coupling portion 62 of the collection container 60. Then, both the second valve 72 and a third valve 63 are switched from the valve closed state to the valve open state. The liquid in the liquid container 18 is moved to the collection container 60 by the water head pressure. In this liquid collection process, the amount of air corresponding to the volume of the liquid that has flowed into the collection container 60 from the liquid container 18 is discharged from the air communication portion 64. Accordingly, the liquid continuously flows into the collection container 60 from the liquid container 18. Substantially all of the liquid in the liquid container 18 is collected in the collection container 60 without spilling. The liquid collected in the collection container 60 is absorbed by the liquid holding member 65. Therefore, even when the collection container 60 is inclined, the liquid does not leak. Then, the user discards the liquid ejecting apparatus 12 after removing the liquid remaining in the liquid container 18.

Therefore, according to the second embodiment, the following effects can be obtained.
(2-1) The liquid discharging portion 71 is configured to be coupled to a coupling target that is separate from the liquid container 18. The liquid container 18 includes the discharge coupling structure portion 75 configured to switch between a state in which the liquid is not discharged from the liquid discharging portion when the liquid discharging portion 71 is not coupled to the coupling target, and a state in which the liquid is to be discharged from the liquid discharging portion 71 when the liquid discharging portion 71 is coupled to the coupling target. With the use of this configuration, when the liquid discharging portion 71 is not coupled to the coupling target, the discharge coupling structure portion 75 prevents the liquid in the liquid containing portion 51 from being discharged from the liquid discharging portion 71. In addition, when the liquid discharging portion 71 is coupled to the coupling target, the discharge coupling structure portion 75 is switched to a state in which the liquid is to be discharged from the liquid discharging portion 71. Therefore, in a normal use state other than when the liquid ejecting apparatus is discarded or the like, it is possible to suppress the liquid in the liquid containing portion to be discharged from the liquid discharging portion. In addition, it is possible to appropriately attach and detach a coupling target such as a collection container to and from the liquid discharging portion while suppressing the liquid leakage.
(2-2) The discharge coupling structure portion 75 has a sealing structure that is detachably attached to the liquid discharging portion 71 and that seals the liquid discharging portion 71 by being attached to the liquid discharging portion 71 when the liquid discharging portion 71 is not coupled to the coupling target. With the use of this configuration, when the liquid discharging portion 71 is not coupled to the coupling target, the discharge coupling structure portion 75 is attached to the liquid discharging portion 71, and thus it is possible to prevent the liquid in the liquid containing portion 51 from being discharged from the liquid discharging portion 71 by the sealing structure of the discharge coupling structure portion 75. For example, in a normal use state other than when the liquid ejecting apparatus 12 is discarded or the like, it is possible to suppress the liquid in the liquid container 18 to be unintentionally discharged from the liquid discharging portion 71. In addition, when the discharge coupling structure portion 75 is detached from the liquid discharging portion 71, the liquid discharging portion 71 can be coupled to the coupling target.
(2-3) The discharge coupling structure portion 75 has a sealing structure that can be broken when the coupling target is coupled. With the use of this configuration, in a normal use state other than when the liquid ejecting apparatus 12 is discarded or the like in which the discharge coupling structure portion 75 is not coupled to the coupling target, it is possible to prevent the liquid in the liquid containing portion 51 from being discharged from the liquid discharging portion 71 by the sealing structure of the discharge coupling structure portion 75. When the discharge coupling structure portion 75 is coupled to the coupling target, the sealing structure of the discharge coupling structure portion 75 is broken, and thus the liquid can be discharged through the liquid discharging portion 71 to the coupling target such as the collection container 60. Therefore, the discharge coupling structure portion 75 can have a simple configuration without having a complicated structure such as a valve.

The above-described embodiments may be modified into the following modifications. Further, an appropriate combination of the above-described embodiments and modifications described below may be used as a further modification, and an appropriate combination of modifications described below may be used as a further modification.

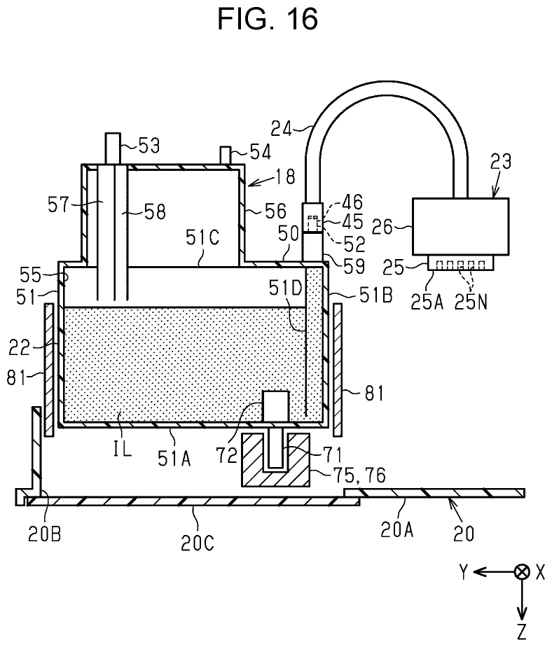

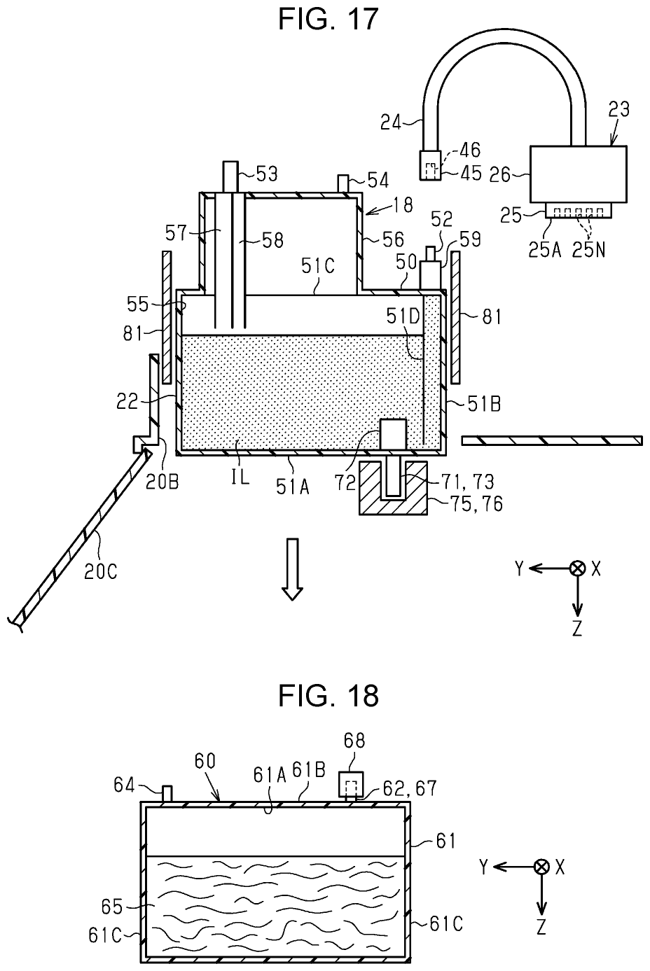

The moving direction when the liquid container 18 is detached from the liquid ejecting apparatus 12 is not limited to the Y direction, and may be another direction. For example, as illustrated in FIGS. 16 and 17, the moving direction when the liquid container 18 is detached from the liquid ejecting apparatus 12 may be the Z direction (downward). As illustrated in FIG. 16, in the housing 20, an opening 20B is provided at a bottom surface 20A below the arrangement position of the liquid container 18, and a cover 20C is provided so as to be able to open/close the opening 20B. In the liquid container 18, the liquid supplying portion 52, to which a coupling portion 45 provided at an upstream end portion of the supply flow path 24 can be coupled, protrudes upward. The coupling direction of the liquid supplying portion 52 and the supply flow path 24 is the Z direction. Therefore, the moving direction in which the liquid container 18 is moved in order to detach the liquid supplying portion 52 from the supply flow path 24 is the Z direction. As illustrated in FIG. 17, the user can move the liquid container 18 in the Z direction along a guide rail 81 by opening the cover 20C. By moving the liquid container 18 in the Z direction along the guide rail 81, the liquid supplying portion 52 and the supply flow path 24 can be detached, and the liquid container 18 can be detached from the bottom portion of the housing as well. The user detaches the sealing member 76 coupled to the liquid discharging portion 71 of the liquid container 18, and then couples the liquid discharging portion 71 of the liquid container 18 to the collection coupling portion 62 of the collection container 60 illustrated in FIGS. 14 and 15, thereby collecting the liquid remaining in the liquid container 18 into the collection container 60 by the water head pressure.

As illustrated in FIG. 18, the collection coupling portion 62 may be provided with a sealing member 68 that seals the collection containing portion 61 so that the liquid in the collection containing portion 61 cannot flow out. In the example illustrated in FIG. 18, the sealing member 68 is a cap member that seals the coupling port of the collection coupling portion 62. The sealing member 68 formed of the cap member is attached to the collection coupling portion 62, for example, by fitting or screwing so as to seal the coupling port. With the use of this configuration, since the collection coupling portion 62 is sealed by the sealing member 68 after the liquid is collected in the collection container 60, it is possible to suppress the leakage of liquid in the collection container 60.

The position of the liquid discharging portion 71 in the liquid containing portion 51 and the position of the collection coupling portion 62 in the collection containing portion 61 may be appropriately changed as long as the liquid can be discharged by the water head pressure.

In the first embodiment, the first valve 59 of the liquid supplying portion 52 may be a manual on-off valve that can be manually opened/closed or may be configured to have a function of a manual on-off valve as well. In this case, the liquid supplying portion 52 may be coupled to the collection container 60. However, when the liquid is collected in another container such as an empty bottle, in a case in which the valve can be opened by a manual operation, the liquid leakage can be suppressed even when the liquid is collected in another container.

In the second embodiment, the second valve 72 of the liquid discharging portion 71 may be a manual on-off valve that is manually opened/closed or may be configured to have a function of a manual on-off valve as well. Also in this case, when the valve can be opened by a manual operation, the liquid leakage can be suppressed even when the liquid is collected in another container such as an empty bottle.

The liquid ejecting apparatus 12 according to the above-described embodiment includes the plurality of liquid containers 18, but may include only one liquid container 18. One liquid container 18 may contain, for example, black ink as the liquid, and the liquid ejecting apparatus 12 may be a printer dedicated to monochrome printing.

The liquid holding member 65 is not limited to a nonwoven fabric, a sponge, a porous material, or the like, and may be a super absorbent polymer (SAP).

In the above-described embodiment, the liquid is collected in the collection container 60 by coupling the liquid discharging portion 71 and the collection containing portion 61, but the liquid in the liquid container 18 may be filled from the liquid discharging portion 71 to the filling port of the collection container 60. For example, an opening of the collection containing portion 61 may be larger than an opening of the liquid discharging portion 71, and the liquid may be filled by the water head pressure from a position where the openings are separated from each other.

In the above-described embodiment, the liquid in the liquid container 18 is collected in the collection container 60 prepared by a manufacturer, an agency, or a dealer but may be collected in another container. For example, the liquid may be collected in an empty liquid bottle 34. As described above, the container of the collection destination may be any container as long as it can contain the collected liquid.

The present disclosure is not limited to collection in a collection container. The liquid may be collected in a plastic bag containing an absorbent material such as a nonwoven fabric. In this case, the collection container need not be prepared. In addition, when the liquid in the liquid container 18 is collected, the liquid can be collected outside by using the water head pressure. Therefore, for example, compared to a case of adopting a method of collecting the liquid by inclining a liquid supply unit, it is easy to prevent the liquid ejecting apparatus 12 and the periphery thereof where the collection work is performed from being contaminated by the liquid such as ink during the collection work.

The moving direction when the liquid container 18 is detached from the housing 20 may be a direction other than the Y direction (forward direction) or the Z direction (downward direction). In short, any direction along the coupling direction of the liquid supplying portion 52 and the supply flow path 24 may be used. For example, the moving direction may be a −Y direction (rearward direction) or a −Z direction (upward direction), or may be the width direction X. When the moving direction is the width direction X, it may be a −X direction (right direction) or a +X direction (left direction). Further, the moving direction may be a direction having components in two directions of the X direction and the Y direction, a direction having components in two directions of the Y direction and the Z direction, or a direction having components in two directions of the X direction and the Z direction. Further, the moving direction may be a direction having components in three directions of the X direction, the Y direction, and the Z direction.

In the liquid ejecting apparatus 12, the arrangement position of the liquid container 18 is not limited to the front right side of the housing 20. For example, it may be the front left side of the housing 20. In addition, the arrangement position of the liquid container 18 may be a side portion of the housing 20 or a rear portion of the housing 20. In addition, in the embodiment, the arrangement position of the liquid container 18 is a position at which the housing 20 has a shape that partially protrudes outside (for example, the front side) but may be a position at which the housing 20 does not protrude outside.

In the above-described embodiment, a so-called off-carriage type in which the liquid container 18 is fixed to a predetermined position in the housing 20 is used, but a so-called on-carriage type in which the liquid container 18 is mounted on the carriage 26 in a fixed state may be used. When the on-carriage type is used.

The liquid ejecting apparatus 12 is not limited to an ink jet printer that performs printing on paper and may be a textile printing apparatus.

A medium M is not limited to paper and may be a film made of a synthetic resin or a fabric such as cloth or nonwoven fabric. Further, the medium M may be a laminated medium including a synthetic resin layer and a metal layer, or a foil or a leaf made of metal.

The liquid ejecting apparatus 12 may be a liquid ejecting apparatus that ejects a liquid other than ink. The state of the liquid that is ejected from the liquid ejecting apparatus in a form of a minute amount of liquid droplets includes a granular shape, a tear shape, and a shape with a thread-like tail. Here, the liquid may be a material that can be ejected from the liquid ejecting apparatus. For example, the liquid may be in a state in which a substance is in a liquid phase, and includes a fluid body such as a liquid body having high or low viscosity, sol, gel water, other inorganic solvents, an organic solvent, a solution, a liquid resin, and a liquid metal (metal melt). The liquid includes not only a liquid as one state of a substance but also a liquid in which particles of a functional material, made of a solid material such as a pigment or a metal particle, are dissolved, dispersed, or mixed in a solvent.

Typical examples of the liquid include ink and liquid crystal as described in the above embodiment. Here, the ink includes various liquid compositions such as commonly used water-based ink, oil-based ink, gel ink, and hot-melt ink. Specific examples of the liquid ejecting apparatus include an apparatus that ejects a liquid containing a material such as an electrode material or a color material used for manufacturing a liquid crystal display, an electroluminescence (EL) display, a surface emitting display, a color filter, or the like in a dispersed or dissolved form. The liquid ejecting apparatus may be an apparatus that ejects a bio-organic substance used for manufacturing a biochip, an apparatus that is used as a precision pipette and ejects a liquid serving as a sample, a textile printing apparatus, a micro dispenser, or the like. The liquid ejecting apparatus may be an apparatus that ejects a lubricating oil to a precision machine such as a watch or a camera in a pinpoint manner, or an apparatus that ejects a transparent resin liquid such as an ultraviolet curable resin onto a substrate to form a micro hemispherical lens (optical lens) or the like used for an optical communication element or the like. The liquid ejecting apparatus may be an apparatus that discharges an etchant such as an acid or an alkali for etching a substrate or the like.

Hereinafter, technical ideas grasped from the embodiment and the modification examples will be described together with effects.

(A) A liquid ejecting apparatus includes an ejecting head configured to eject a liquid and a liquid container configured to contain a liquid to be supplied to the ejecting head. The liquid container includes a liquid containing portion configured to contain a liquid, a liquid filling portion through which a liquid is filled into the liquid containing portion, a liquid supplying portion to which one end portion of a supply flow path for supplying the liquid to the ejecting head is coupled and through which the liquid in the liquid containing portion is supplied, and a liquid discharging portion through which the liquid contained in the liquid containing portion is discharged outside. The liquid discharging portion is disposed at a bottom surface or a lower portion of a side surface of the liquid containing portion.

With the use of this configuration, the liquid ejecting apparatus can discharge the liquid remaining in the liquid container outside through the liquid discharging portion disposed at the bottom surface or the lower portion of the side surface of the liquid containing portion. Therefore, it is possible to discard the liquid ejecting apparatus after discharging the liquid remaining in the liquid container outside.

(B) In the liquid ejecting apparatus according to (A), the liquid supplying portion may also serve as the liquid discharging portion. With the use of this configuration, since the liquid supplying portion also serves as the liquid discharging portion, a simple configuration is sufficient.

(C) In the liquid ejecting apparatus according to (A), the liquid supplying portion and the liquid discharging portion may be separate from each other. With the use of this configuration, since the liquid supplying portion and the liquid discharging portion are separate from each other, the degree of freedom in selecting the arrangement position of each of the liquid supplying portion and the liquid discharging portion in the liquid containing portion is increased. Therefore, the liquid supplying portion and the liquid discharging portion can be disposed at appropriate positions in the liquid containing portion.

(D) In the liquid ejecting apparatus according to any one of (A) to (C), the liquid supplying portion may include a first valve that can open/close a flow path through which the liquid is supplied.

With the use of this configuration, supply/non-supply of the liquid via the liquid supplying portion can be selected by the valve. For example, the valve is opened when the liquid supplying portion is coupled to a coupling target such as a flow path for supplying the liquid to the ejecting head, and the valve is closed when the coupling to the coupling target is released. Thus, the liquid can appropriately be supplied to the ejecting head while the leakage of liquid from the liquid supplying portion is suppressed.

(E) In the liquid ejecting apparatus according to any one of (A) to (D), the liquid discharging portion may include a second valve that can open/close a flow path through which the liquid is discharged. With the use of this configuration, discharge/non-discharge of the liquid via the liquid discharging portion can be selected by the second valve. For example, the valve is opened when the liquid discharging portion is coupled to a coupling target such as a collection container, and the valve is closed when the coupling to the coupling target is released. Thus, the liquid can appropriately be discharged outside while the leakage of liquid from the liquid discharging portion is suppressed.

(F) In the liquid ejecting apparatus according to any one of (A) to (E), the liquid discharging portion may be configured to be coupled to a coupling target separate from the liquid container. The liquid container may include a discharge coupling structure portion configured to switch between a state in which the liquid is not discharged from the liquid discharging portion when the liquid discharging portion is not coupled to the coupling target, and a state in which the liquid is to be discharged from the liquid discharging portion when the liquid discharging portion is coupled to the coupling target.

With the use of this configuration, the discharge coupling structure portion switches between a state in which the liquid in the liquid containing portion is not discharged from the liquid discharging portion when the liquid discharging portion is not coupled to the coupling target, and a state in which the liquid is to be discharged from the liquid discharging portion when the liquid discharging portion is coupled to the coupling target. Therefore, in a normal use state other than when the liquid ejecting apparatus is discarded or the like, it is possible to suppress the liquid in the liquid containing portion to be discharged from the liquid discharging portion. In addition, it is possible to appropriately attach and detach a coupling target such as a collection container to and from the liquid discharging portion while suppressing the liquid leakage.

(G) In the liquid ejecting apparatus according to (F), the discharge coupling structure portion may have a sealing structure that is detachably attached to the liquid discharging portion and that seals the liquid discharging portion by being attached to the liquid discharging portion when the liquid discharging portion is not coupled to the coupling target. With the use of this configuration, when the liquid discharging portion is not coupled to the coupling target, detachably attaching the discharge coupling structure portion to the liquid discharging portion makes it possible to prevent the liquid in the liquid containing portion from being discharged from the liquid discharging portion by the sealing structure. For example, in a normal use state other than when the liquid ejecting apparatus is discarded or the like, it is possible to suppress the liquid in the liquid container to be unintentionally discharged from the liquid discharging portion. In addition, detaching the discharge coupling structure portion from the liquid discharging portion makes it possible to couple the liquid discharging portion to the coupling target.

(H) In the liquid ejecting apparatus according to (F) or (G), the discharge coupling structure portion may have a sealing structure which can be broken when the coupling target is coupled. With the use of this configuration, when the discharge coupling structure portion is coupled to the coupling target, the sealing structure is broken, and thus it is possible to discharge the liquid through the liquid discharging portion to the coupling target such as the collection container. Therefore, it is possible to simplify the sealing structure without employing a complicated structure such as a valve.

(I) In the liquid ejecting apparatus according to any one of (A) to (H), the liquid container may be fixed to the liquid ejecting apparatus by a fixing portion. With the use of this configuration, since the liquid container is fixed to the liquid ejecting apparatus by the fixing portion, it is easy to prevent the one end portion of the supply flow path from coming off from the liquid supplying portion of the liquid container.

What is claimed is:

1. A liquid ejecting apparatus, comprising:
an ejecting head configured to eject a liquid; and
a liquid container configured to contain a liquid to be supplied to the ejecting head, wherein
the liquid container includes
a liquid containing portion configured to contain a liquid,
a liquid filling portion through which a liquid is filled into the liquid containing portion,
a liquid supplying portion to which one end portion of a supply flow path for supplying the liquid to the ejecting head is coupled and through which the liquid in the liquid containing portion is supplied, and
a liquid discharging portion through which the liquid contained in the liquid containing portion is discharged outside, and
the liquid discharging portion is disposed at a bottom surface or a lower portion of a side surface of the liquid containing portion.

2. The liquid ejecting apparatus according to claim 1, wherein
the liquid supplying portion also serves as the liquid discharging portion.

3. The liquid ejecting apparatus according to claim 1, wherein
the liquid supplying portion and the liquid discharging portion are separate from each other.

4. The liquid ejecting apparatus according to claim 3, wherein
the liquid supplying portion includes a first valve configured to open/close a flow path through which the liquid is supplied.

5. The liquid ejecting apparatus according to claim 3, wherein
the liquid discharging portion includes a second valve configured to open/close a flow path through which the liquid is discharged.

6. The liquid ejecting apparatus according to claim 3, wherein
the liquid discharging portion is configured to be coupled to a coupling target separate from the liquid container, and
the liquid container includes a discharge coupling structure portion configured to switch between a state in which the liquid is not discharged from the liquid discharging portion when the liquid discharging portion is not coupled to the coupling target, and a state in which the liquid is to be discharged from the liquid discharging portion when the liquid discharging portion is coupled to the coupling target.

7. The liquid ejecting apparatus according to claim 6, wherein
the discharge coupling structure portion has a sealing structure that is configured to be attached/detached to/from the liquid discharging portion and that seals the liquid discharging portion by being attached to the liquid discharging portion when the liquid discharging portion is not coupled to the coupling target.

8. The liquid ejecting apparatus according to claim 6, wherein
the discharge coupling structure portion has a sealing structure configured to be broken when the coupling target is coupled.

9. The liquid ejecting apparatus according to claim 6, wherein
the liquid container is fixed to the liquid ejecting apparatus by a fixing portion.
